(19) United States
(12) Patent Application Publication
(10) Pub. No.: US 2017/0172197 A1
(43) Pub. Date: Jun. 22, 2017

(54) COFFEE ROASTING DEVICE

(71) Applicant: Sung Soo HAN, Seoul (KR)

(72) Inventor: Sung Soo HAN, Seoul (KR)

(21) Appl. No.: 15/452,747

(22) Filed: Mar. 8, 2017

Related U.S. Application Data
(63) Continuation of application No. PCT/KR2015/011455, filed on Oct. 28, 2015.

(30) Foreign Application Priority Data
Nov. 28, 2014 (KR) 10-2014-0168910

(51) Int. Cl. A23N 12/10

(52) U.S. Cl. CPC A23N 12/10

(57) ABSTRACT

The present invention relates to a coffee roasting device, and may comprise: a body; a rotating unit rotatably fastened/fixed to the upper portion of the body, a part of one side surface of the rotating unit being incised in the longitudinal direction, thereby forming an entrance/exit, and coffee beans being contained inside the rotating unit via the entrance/exit; a heating unit positioned inside the rotating unit and supplied with external power, thereby generating heat; a driving unit positioned on one side of the rotating unit, the driving unit providing the rotating unit with rotating power; and a partition attached/fixed to the inner surface of the rotating unit so as to prevent the coffee beans from being discharged to the outside via the entrance/exit.

### CROSS-REFERENCES TO RELATED APPLICATIONS

This Application claims the benefit of priority and is a Continuation application of the prior International Patent Application No. PCT/KR2015/011455, with an international filing date of Oct. 28, 2015, which designated the United States, and is related to the Korean Patent Application No. 10-2014-0168910, filed Nov. 28, 2014, the entire disclosures of all applications are expressly incorporated by reference in their entirety herein.

### BACKGROUND OF THE INVENTION

1. Field of the Invention

The present invention relates to a coffee roasting device, and more particularly, to a coffee roasting device which can reduce fuel costs by using a heater inserted into a rotating unit, and can maximize thermal efficiency by evenly spreading heat applied to the inside of the rotating unit.

2. Description of Related Art

In general, a coffee bean itself has no taste or flavor, but, when coffee beans are heated at high temperature, that is, are roasted, various ingredients (fat, sugar, organic acid, caffeine, or the like) are activated while cellular tissue of the coffee beans is destroyed, and the taste and flavor of coffee is generated. Coffee is extracted from coffee beans by going through a hand picking process of selecting poor beans from harvested coffee beans, a roasting process of roasting selected coffee beans, a grinding process of forming coffee powder by grinding roasted coffee beans, and a brewing process of extracting coffee by passing boiling water through coffee powder.

The most important process in determining the taste and flavor of coffee in these processes depends on how well coffee beans are roasted. Therefore, various devices for roasting coffee beans well have been suggested in the prior art, and a representative example thereof is suggested in Korean Patent Publication No. 10-2012-0053640, which discloses a method for roasting coffee beans in a direct-fired type.

However, the related-art method may cause a phenomenon in which coffee beans directly contacting a flame in a roasting process are burnt on the outside before they are roasted on the inside, which results in poor coffee beans in the roasting process. If poor coffee beans are generated in the roasting process, the poor coffee beans should be selected and removed, and, if the poor coffee beans are not selected and all of the roasted coffee beans are carried to the next process, the taste and flavor of coffee become unpleasant.

In addition, the related-art method has a disadvantage that coffee beans contacting a flame are not evenly roasted, and, since coffee beans are roasted in the direct-fired type, the roasting process should be performed by a skilled worker, and thus it is difficult for various classes of users to generally use the direct-fired roasting process.

### BRIEF SUMMARY OF THE INVENTION

The present invention provides a coffee roasting device, which can reduce fuel costs by using a heater inserted into a rotating unit, and can maximize thermal efficiency by evenly spreading heat applied to the inside of the rotating unit.

In addition, the present invention provides a coffee roasting device, which can prevent coffee beans contained in a drum from being discharged to the outside when the drum is rotated, by using a partition attached to the inside of the drum, and easily mixes coffee beans heated in the drum.

Various objects to be achieved by the present invention are not limited to the above-mentioned objects, and other objects not mentioned herein could be clearly understood by a person skilled in the art based on the following description.

According to the present invention, a coffee roasting device includes: a body; a rotating unit rotatably fastened and fixed to the upper portion of the body, a part of one side surface of the rotating unit being incised in a longitudinal direction, thereby forming an entrance/exit, coffee beans being contained inside the rotating unit via the entrance/exit; a heating unit positioned inside the rotating unit and supplied with external power to generate heat; a driving unit positioned at one side of the rotating unit, the driving unit providing the rotating unit with rotation power; and a partition attached and fixed to the inner surface of the rotating unit so as to prevent the coffee beans from being discharged to the outside via the entrance/exit.

The body may further include: a controller configured to control power supplied to the rotating unit and the heating unit; a guide unit disposed on the lower portion of the rotating unit so as to guide and move the coffee beans discharged from the rotating unit; and a storage configured to store the heated coffee beans dropping down from the guide unit for a predetermined time so as to be cooled.

The rotating unit may include; a drum which has the entrance/exit formed on one side thereof in the longitudinal direction so as to allow the coffee beans to enter or be discharged therethrough, the drum having a pipe inserted thereinto and fixed thereto, passing through the centers of the opposite sides of the drum, opposite sides of the pipe being inserted into bearings provided on the body and rotatably supported; an insulator which is fastened and fixed to enclose the outer circumference of the drum, the insulator having a first opening 231 formed on a same location and in a same shape as those of the entrance/exit formed on the drum, and an opening portion extending from the first opening to allow the inside of the drum to be seen; and a cover which is fastened and fixed to enclose the outer circumference of the insulator, the cover having a second opening formed on a same location as that of the first opening formed on the insulator 230, and a second transparent window formed on a same location as that of the opening portion formed on the insulator to allow the inside of the drum to be seen through the opening portion.

The partition may include: a fixing piece attached and fixed to the inner surface of the rotating unit; an extension piece extending from the fixing piece and bent by a predetermined angle to face the center of the rotating unit; and a first transparent window formed by incising a part of a front surface of the fixing piece so as to allow the inside of the rotating unit to be seen, and the first transparent window may be formed of transparent glass so as to allow a user to check color of coffee beans seated on a seating piece.

Detailed matters of other embodiments are included in the detailed description and drawings.

The coffee roasting device according to the present invention can reduce fuel costs by using a heater inserted into a rotating unit, and can maximize thermal efficiency by evenly spreading heat applied to the inside of the rotating unit.

In addition, the coffee roasting device according to the present invention can prevent coffee beans contained in the drum from being discharged to the outside when the drum is rotated, by using the partition attached to the inside of the drum, and easily mixes coffee beans heated in the drum.

It will be clearly understood that various embodiments of the present invention can provide various effects not mentioned in detail herein.

### BRIEF DESCRIPTION OF THE DRAWINGS

FIG. 1 is an exploded perspective view of a coffee roasting device according to the present invention;

FIG. 2 is a perspective view of the coffee roasting device in an assembled state according to the present invention;

FIG. 3 is a front view of the coffee roasting device according to the present invention;

FIG. 4 is a side view of the coffee roasting device according to the present invention;

FIG. 5 is a view enlarging the side surface of a rotating unit in the coffee roasting device according to the present invention; and

FIG. 6 is a view showing a state in which the rotating unit is rotated in the coffee roasting device according to the present invention.

### DETAILED DESCRIPTION OF THE INVENTION

Exemplary embodiments will now be described more fully with reference to the accompanying drawings to clarify aspects, features and advantages of the present invention. The exemplary embodiments may, however, be embodied in many different forms and should not be construed as limited to the exemplary embodiments set forth herein. Rather, the exemplary embodiments are provided so that this disclosure will be thorough and complete, and will fully convey the scope of the application to those of ordinary skill in the art. In the drawings, thickness of layers and areas are exaggerated for the sake of clarity.

The terms such as “first” and “second” may be used to explain various elements, and do not limit the corresponding elements. These terms may be used for the purpose of distinguishing one element from another element. For example, a first element may be referred to as a second element without departing from the scope of right of the present invention, and similarly, a second element may be referred to as a first element.

The terms “upper end,” “lower end,” “top surface,” “bottom surface,” “upper portion,” or “lower portion” may be used to distinguish relative positions of elements.

For example, when the upper side on the drawings is referred to as the upper portion and the underside on the drawings is referred to as the lower portion, the upper portion may be referred to as the lower portion and the lower portion may be referred to as the upper portion in practice without departing from the right scope of the present invention.

The terms used herein are for the purpose of describing particular embodiments only and are not intended to be limiting. As used herein, the singular forms are intended to include the plural forms as well, unless the context clearly indicates otherwise. It should be understood that the terms “include” or “have” used in the present application indicate the presence of features, numbers, steps, operations, elements, and components described in the specification, or a combination thereof, and do not preclude the presence or addition of one or more other features, numbers, steps, operation, elements, or components, or a combination thereof.

All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having ideal or exaggerated meanings unless they are clearly defined in the various exemplary embodiments.

Hereinafter, preferred embodiments of a coffee roasting device according to the present invention will be described in detail with reference to the accompanying drawings.

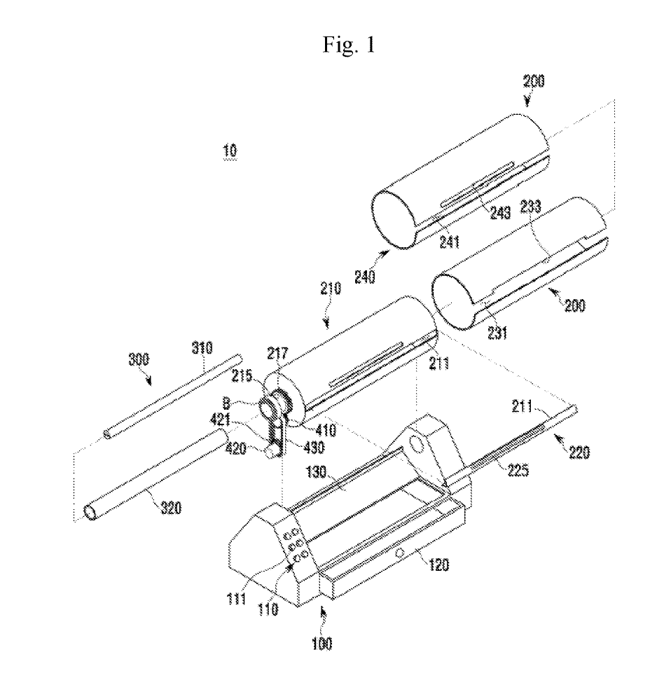

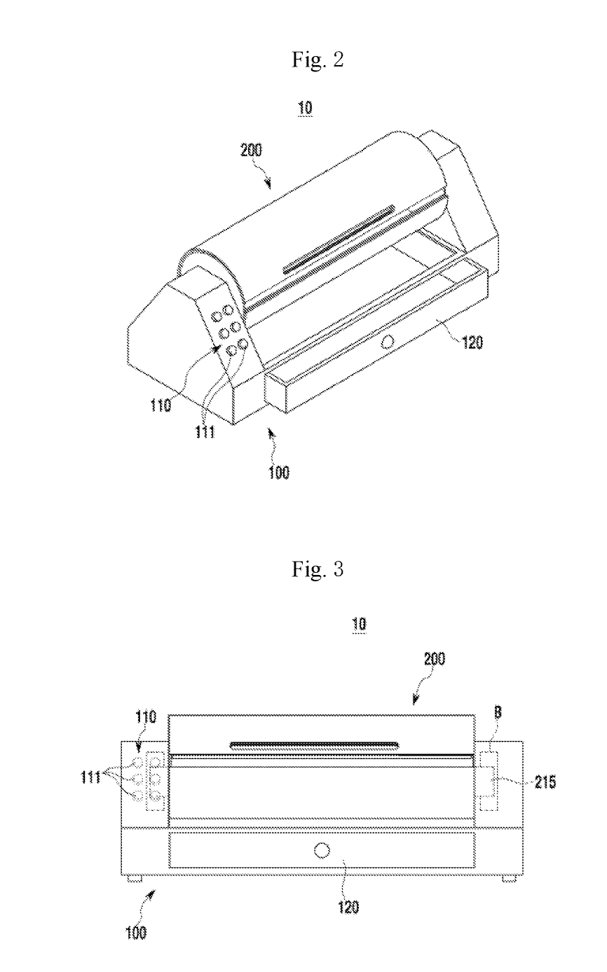

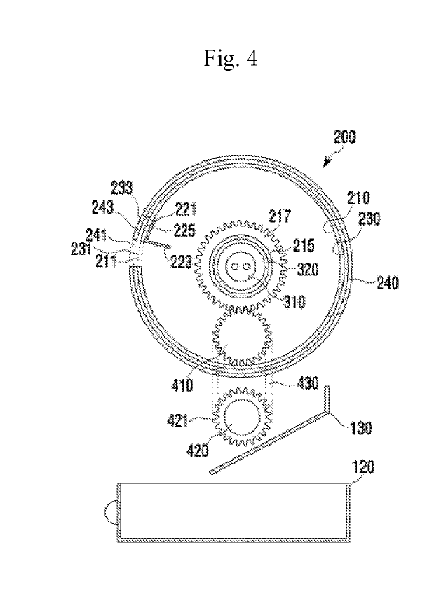

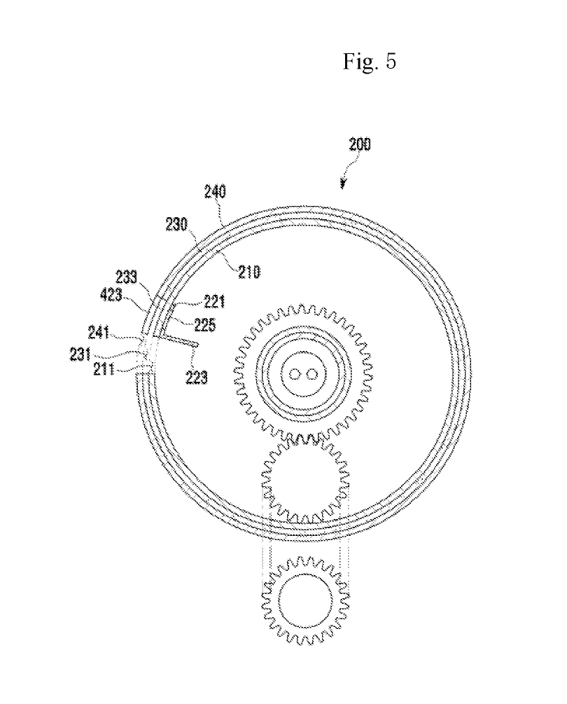

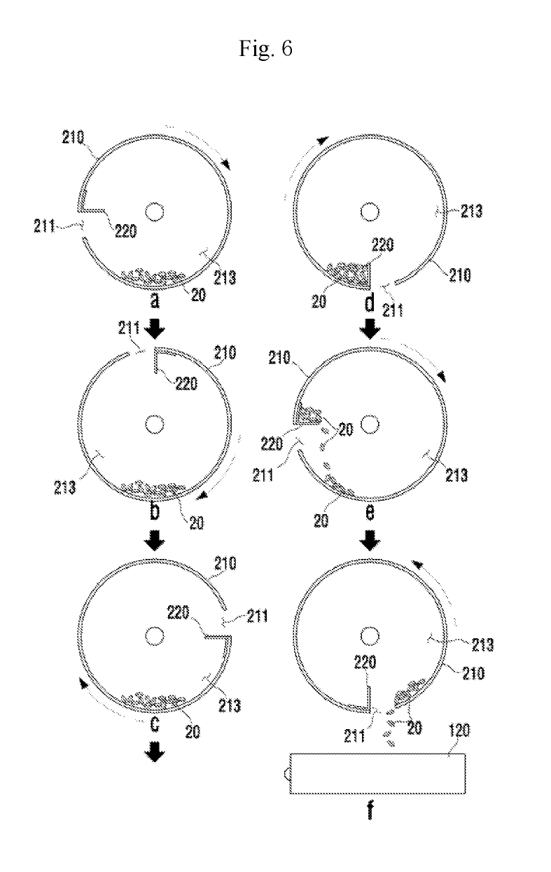

FIG. 1 is an exploded perspective view of a coffee roasting device according to the present invention, FIG. 2 is a perspective view of the coffee roasting device in an assembled state according to the present invention, FIG. 3 is a front view of the coffee roasting device according to the present invention, FIG. 4 is a side view of the coffee roasting device according to the present invention, FIG. 5 is a view enlarging the side surface of a rotating unit in the coffee roasting device according to the present invention, and FIG. 6 is a view showing a state in which the rotating unit is rotated in the coffee roasting device according to the present invention.

Referring to FIGS. 1 to 6, the coffee roasting device 10 according to the present invention may include a body 100, a rotating unit 200, a heating unit 300, and a driving unit 400.

The body 100 may be provided to fix and support the components of the coffee roasting device 10. The body 100 may include a controller 110 provided on the front surface thereof, a storage 120 provided in the lower portion thereof, for storing heated coffee beans 20, and a guide unit 130 provided on the upper portion of the storage 120, for guiding the coffee beans 20 discharged from the rotating unit 200 to the storage 120.

The controller 110 may be provided to supply power to the driving unit 400 to rotate the rotating unit 200, and to supply power to the heating unit 300 to apply heat to the inside of the rotating unit 200 and allow the coffee beans 20 stored in the rotating unit 200 to be roasted by heat. The controller 110 may program time for heating the coffee beans 20 by phase according to a user manipulation on a button 111, and may supply power to the driving unit 400 and the heating unit 300 according to an electric signal of the controller 110 so as to roast the coffee beans to have the best taste and flavor. The button 111 may include various buttons 111 such as a power button, an enter button, a timer button, a temperature display window, or the like.

The storage 120 may be disposed in the lower portion of the body 100, and may be formed in a drawer shape so as to slide in or out the body 100, and may be provided to store the coffee beans 20 discharged from the rotating unit 200 for a predetermined time. Since the coffee beans 20 heated in the rotating unit 200 cannot be directly used, the storage 120 may store the coffee beans 20 until they are cooled. A handle may be provided on the front surface of the storage 120 to allow a user to easily use the storage 120.

The guide unit 130 may be formed in a thin plate shape and may be inclined, and may be provided to guide the coffee beans 20 discharged from the rotating unit 200 to the storage 120. In addition, the guide unit 130 may have a plurality of protrusions formed on the surface thereof, and, when the coffee beans 20 free-fall to the protrusions, impurities attached to the surfaces of the coffee beans 20 may fall away due to impacts made by the falling coffee beans.

The rotating unit 200 may be rotatably fastened and fixed to the upper portion of the body 100 and may be provided to evenly roast the coffee beans 20 heated by the heating unit 300. The rotating unit 200 may include a drum 210, a partition 220, an insulator 230, and a cover 240.

The drum 210 may be formed in a cylindrical shape and have opposite sides closed, so as to form a container 213 for containing the coffee beans 20, and may be formed of fireproof glass of a transparent material. A part of one side surface of the drum 210 is incised in the longitudinal direction, thereby forming an entrance/exit 211 to allow the coffee beans 20 to enter or be discharged therethrough.

In addition, a pipe 215 may be inserted into and fixed to the inside of the drum 210, passing through the centers of opposite sides of the drum 210, so as to allow the heating unit 300 to be inserted into the drum 210.

The pipe 215 may be provided with a first gear 217 at one side thereof, and the first gear 217 may be connected to the driving unit 400 and may be provided to receive rotation power generated in the driving unit 40 and rotate the drum 210. The pipe 215 may be formed in a tubular shape, and may be longer than the length of the drum 210 to protrude from the opposite sides of the drum 210, and the heating unit 300 may be inserted into and fixed to the inside of the pipe 215. In addition, the opposite sides of the pipe 215 may be inserted into bearings (B) provided on the upper portion of the body 100, and the pipe 215 may be rotated about the center shaft of the bearings B.

The partition 220 may include a fixing piece 221 attached and fixed to the inner surface of the drum 210, and an extension piece 223 extending from the fixing piece 221 and bent by a predetermined angle to face the center of the drum 210. The partition 220 may be attached and fixed to the inner circumference of the drum 210 in the proximity of the entrance/exit 211 formed on the drum 210, and may be provided to prevent the coffee beans 20 from being discharged to the entrance/exist 211 formed on the drum 210 when the drum 210 is rotated. That is, when the drum 210 is continuously rotated in the normal direction and the entrance/exit 211 of the drum 210 is located facing down, the coffee beans 20 contained in the drum 210 are rotated together due to the presence of the partition 220, and, when the drum 210 is rotated by more than a predetermined angle, the coffee beans 20 drop down to the lower end of the container 210 again due to the weight. By repeating these operations using the drum 210 having the partition 220 attached thereto and changeable in its position so as to often mix the coffee beans 20, the coffee beans 20 is evenly roasted in comparison with a related-art roasting device, which roasts coffee beans only on the lower end of a drum and does not evenly roast the coffee beans.

In addition, in order to discharge the coffee beans 20 processed in the drum 210, the drum 210 may be rotated in the reverse direction so as to have the entrance/exit 211 face down, and allow the coffee beans 20 to be discharged and moved to the storage 120 along the guide unit 130.

The fixing piece 221 may have a first transparent window 225 formed thereon so as to allow the user to check the state of the coffee beans 20 heated inside the drum 210 from the outside with naked eyes.

A related-art device has inconvenience that a user should insert an extra coffee bean detection device into a drum in order to check the color of roasted coffee beans, and should draw out the coffee bean detection device to check the state of the coffee beans. However, by forming the first transparent window 225 on the partition 220 attached to the inside of the drum 200 and using the same, some of the coffee beans 20 rotated together by the partition 220 when the drum 210 is rotated are seated on the partition 220, such that the user can often check the state of the coffee beans 20 seated on the partition 220 via the first transparent window 225. Herein, the drum 210 may be rotated at such a speed that the user can check the color of the coffee beans 20 with naked eyes.

The insulator 230 may be fastened and fixed so as to enclose the outer circumference of the drum 210, and may be provided to prevent heat generated inside the drum 210 from being discharged to the outside. The insulator 230 may be formed in the same shape as that of the drum 210, and may have a first opening 231 formed on the same location as that of the entrance/exit 211 of the drum 210 so as to allow the coffee beans 20 to enter or be discharged therethrough.

In addition, the insulator 230 may have an opening portion 233 formed on the same location as that of the first transparent window 225 formed on the fixing piece 221 so as to allow the inside of the drum 210 to be seen through the opening portion 233. The insulator 230 may be formed of ceramic wool so as to absorb heat generated in the drum 210 and reflect heat toward the inside of the drum 210.

The cover 240 may be fastened and fixed to enclose the outer circumference of the insulator 230, and may be provided to prevent the insulator 230 from being damaged by an external shock. The cover 240 may have a second opening 241 formed on the same location as that of the first opening 231 formed on the insulator 230, and may have a second transparent window 243 formed on the same location as that of the opening portion 233 formed on the insulator 230.

The coffee beans 20 may enter or may be discharged from the inside of the rotating unit 200 via the second opening 241 formed on the cover 240, the first opening 231 formed on the insulator 230, and the entrance/exit 211 formed on the drum 210.

The heating unit 300 may be located inside the drum 210 and may be provided to emit heat toward the inside of the drum 210 and allow the coffee beans 20 to be roasted. The heating unit 300 may include a heater 310 and a protection pipe 320.

The heater 310 may be inserted into and fixed to the inside of the pipe 215 provided in the drum 210, and may be supplied with power from the controller 110 to generate heat. The heater 310 may be used by using a halogen lamp consuming less power, but this should not be considered as limiting. Any device that can generate heat by electricity may be used.

The protection pipe 320 may be provided to prevent the heater 310 from being damaged by an external shock. The protection pipe 320 may be formed in a tubular shape having a hollow formed therein, and may be fastened and fixed to the heater 310 and may be inserted into and fixed to the inside of the pipe 215 formed in the drum 210.

The driving unit 400 may be disposed at one side of the rotating unit 200, and may be provided to provide rotation power to the rotating unit 200. The driving unit 400 may include a second gear 410 engaged with the first gear 217, a motor 420 for providing power to the second gear 410, and a chain 430 connected with the second gear 410 and a third gear 421 provided on the motor 420, for transmitting power provided from the motor 420 to the second gear 410.

While preferred embodiments of the present invention have been described with reference to the accompanying drawings, it should be understood by a person skilled in the art to which the present invention belongs that the present invention can be embodied in other specific forms without changing the technical idea or essential features of the present invention. Therefore, it should be understood that the embodiments described above are merely examples in all aspects and are not limited.

What is claimed is:

1. A coffee roasting device comprising:
a body;
a rotating unit rotatably fastened and fixed to the upper portion of the body, a part of one side surface of the rotating unit being incised in a longitudinal direction, thereby forming an entrance/exit, coffee beans being contained inside the rotating unit via the entrance/exit;
a heating unit positioned inside the rotating unit and supplied with external power to generate heat;
a driving unit positioned at one side of the rotating unit, the driving unit providing the rotating unit with rotation power; and
a partition attached and fixed to the inner surface of the rotating unit so as to prevent the coffee beans from being discharged to the outside via the entrance/exit.

2. The coffee roasting device of claim 1, wherein the body further comprises:
a controller configured to control power supplied to the rotating unit and the heating unit;
a guide unit disposed on the lower portion of the rotating unit so as to guide and move the coffee beans discharged from the rotating unit; and
a storage configured to store the heated coffee beans dropping down from the guide unit for a predetermined time so as to be cooled.

3. The coffee roasting device of claim 1, wherein the rotating unit comprises:
a drum which has the entrance/exit formed on one side thereof in the longitudinal direction so as to allow the coffee beans to enter or be discharged therethrough, the drum having a pipe inserted thereinto and fixed thereto, passing through the centers of the opposite sides of the drum, opposite sides of the pipe being inserted into bearings provided on the body and rotatably supported;
an insulator which is fastened and fixed to enclose the outer circumference of the drum, the insulator having a first opening formed on a same location and in a same shape as those of the entrance/exit formed on the drum, and an opening portion extending from the first opening to allow the inside of the drum to be seen; and
a cover which is fastened and fixed to enclose the outer circumference of the insulator, the cover having a second opening formed on a same location as that of the first opening formed on the insulator, and a second transparent window formed on a same location as that of the opening portion formed on the insulator to allow the inside of the drum to be seen through the opening portion.

4. The roasting device of claim 1, wherein the partition comprises:
a fixing piece attached and fixed to the inner surface of the rotating unit;
an extension piece extending from the fixing piece and bent by a predetermined angle to face the center of the rotating unit; and
a first transparent window formed by incising a part of a front surface of the fixing piece so as to allow the inside of the rotating unit to be seen, and
wherein the first transparent window is formed of transparent glass so as to allow a user to check color of coffee beans seated on a seating piece.
